(19) United States
(12) Patent Application Publication
(10) Pub. No.: US 2005/0206633 A1
(43) Pub. Date: Sep. 22, 2005

(54) Information display

(76) Inventor: Tomohiro Mukai, Suwa--shi (JP)

Correspondence Address: HARNESS, DICKEY & PIERCE, P.L.C., P.O. BOX 828, BLOOMFIELD HILLS, MI, 48303, US

(21) Appl. No.: 11/049,624

(22) Filed: Feb. 2, 2005

(30) Foreign Application Priority Data
Feb. 4, 2004 (JP) 2004-027714

(51) Int. Cl. G09G 5/00

(52) U.S. Cl. 345/204

(57) ABSTRACT

An information display that displays a predetermined image on a reflective display element, wherein the ambient illumination of the reflective display element is detected by an illumination sensor 9, and when the illumination area (illumination area A, B, C or D) of the detected illumination has changed, an interrupt signal is output from an interrupt controller 10, and when the interrupt signal was output the luminance of an image that is displayed on the reflective display element is corrected by a display controller 6.

### BACKGROUND OF THE INVENTION

1. Field of the Invention

The present invention relates to an information display that displays a predetermined image on a reflective display element.

2. Description of the Related Art

Conventional display apparatuses of this kind include, for example, as described in JP11-271799A, a display that displays an image of the contents of an electronic book on a reflective display element such as a cholesteric liquid crystal panel or an electrophoretic display, to allow a user to view the displayed image.

However, in the aforementioned conventional display apparatus, because the display is a reflective display element, that is, a display that carries out a display function by utilizing the reflected light of light incident on the display screen to display an image of the contents on the display element, for example, in an environment in which only a small amount of light is incident on the display screen, there is a concern that the visibility of the image that is the display object will be lessened.

This invention has been made to solve the above-described unsolved problem of the conventional art, and an object of this invention is to provide an information display that can enhance the visibility of an image that is the display object under a variety of illumination environments.

### SUMMARY OF THE INVENTION

To solve the aforementioned problem, the information display of this invention is an information display that displays a predetermined image on a reflective display element, wherein the information display comprises an illumination detection section that detects the ambient illumination of the reflective display element, and a luminance correction section that corrects the luminance of an image that is displayed on the reflective display element based on the illumination that was detected by the illumination detection section.

According to this configuration, when correcting the luminance of an image displayed on a reflective display element based on the ambient illumination, correction can be carried out that is suitable to each illumination situation, thereby enabling the visibility of an image that is the display object to be enhanced under various environments.

Further, the luminance correction section may be configured to select a luminance correction table that corresponds with the illumination that was detected by the illumination detection section from a plurality of prepared luminance correction tables, and to correct the luminance of an image that is displayed on the reflective display element on the basis of the selected luminance correction table.

According to this configuration, by selecting a suitable luminance correction table, correction can be carried out that is appropriate to each illumination situation, to thereby enable easy enhancement of the visibility of the image that is the display object.

The luminance correction section may also be configured to select a luminance correction table that, when the illumination detected by the illumination detection section is equal to or greater than a predetermined illumination, corrects the luminance of apart of the image that is displayed on the reflective display element that is less than or equal to a predetermined luminance to lower the luminance.

According to this configuration, for example, when in an environment in which ambient illumination of the reflective display element is noticeably large, and a noticeably large amount of light is thus incident on the display screen, the light amount of reflected light from a high luminance part of the image that is the display object can be reduced to enable the visibility of the image that is the display object to be enhanced.

Further, the luminance correction section may be configured to select a luminance correction table that, when the illumination detected by the illumination detection section is less than or equal to a predetermined illumination, corrects the luminance of apart of the image that is displayed on the reflective display element that is less than or equal to a predetermined luminance to lower the luminance.

According to this configuration, for example, when in an environment in which the ambient illumination of the reflective display element is low and the amount of light that is incident on the display screen is small, the luminance of a halftone part of the image that is the display object can be corrected by lowering the luminance. Also, when the contours of characters included in the image that is the display object are subjected to halftoning, the visibility of the image that is the display object can be enhanced by lowering (darkening) the luminance of the contours to display characters for which the contrast of the contours is high.

The information display may also comprise a CPU that generates raster data for an image to be displayed on the reflective display element, and a display controller that directly displays the raster data generated by the CPU on the reflective display element, wherein the luminance correction section corrects luminance data that is included in the raster data generated by the raster data generating section.

According to this configuration, the production cost of the information display can be lessened, for example, in comparison to a method that stores raster data in a VRAM and then corrects the stored raster data.

Further, the information display may comprise a CPU that generates raster data for an image to be displayed on the reflective display element, a VRAM that stores the raster data generated by the CPU, and a display controller that displays the raster data that is stored in the VRAM on the reflective display element, wherein the luminance correction section corrects luminance data that is included in the raster data that is stored in the VRAM.

According to this configuration, for example, the CPU load can be reduced in comparison to a method that directly corrects raster data and displays the raster data in that state without storing the raster data in a VRAM.

### BRIEF DESCRIPTION OF THE DRAWINGS

FIG. 1 is a configuration diagram that shows one embodiment of the information display of this invention;

FIG. 2 is a flowchart that illustrates interrupt processing that is executed by an interrupt controller;

FIG. 3 is an explanatory drawing for explaining the relation between illumination and illumination areas;

FIG. 4 is a flowchart that illustrates display control processing that is executed by a display controller; and

FIG. 5 is an explanatory drawing for explaining LUTs for luminance correction.

### DETAILED DESCRIPTION OF THE PREFERRED EMBODIMENTS

Hereunder, one embodiment of the information display of this invention is described based on the drawings.

<Configuration of Portable Information Terminal>

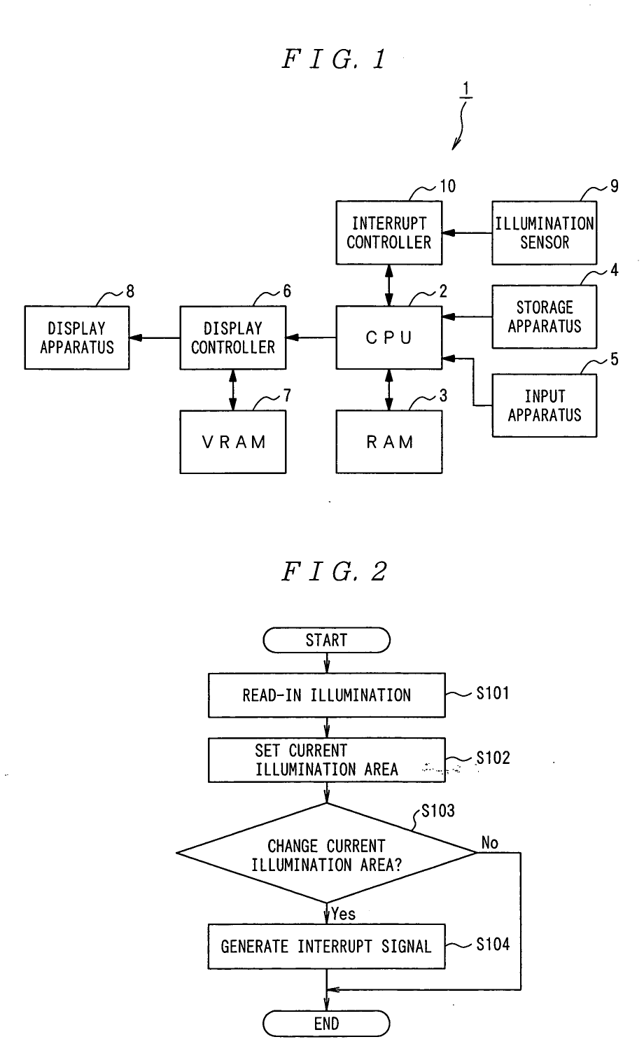

FIG. 1 is a block diagram showing an abbreviated configuration of a portable information terminal 1 of one embodiment of this invention. As shown in FIG. 1, the portable information terminal 1 is composed of a CPU (Central Processing Unit) 2, a RAM (Random Access Memory) 3, a storage apparatus 4, an input apparatus 5, a display controller 6, a VRAM (Video RAM) 7, a display apparatus 8, an illumination sensor 9 and an interrupt controller 10.

Of these components, the CPU 2 reads out data and various programs such as a primary control program that are stored in the storage apparatus 4, and expands these various programs and data in a work area provided within the RAM 3 and performs execution thereof, to thus execute control of each part comprising the portable information terminal 1. Further, in accordance with a depression signal (described later) that is input from the input apparatus 5, the CPU 2 reads a specified image from the storage apparatus 4 and outputs the raster data of that image to the display controller 6.

In addition, when data of a current illumination area (described later) and an interrupt signal (described later) are output from the interrupt controller 10, the CPU 2 outputs data of a current illumination area (described later) and a refresh instruction to the display controller 6.

The RAM 3 forms a work area that is used for expanding various programs and also forms a memory area for storing data relating to various kinds of processing executed by the CPU 2.

The storage apparatus 4 stores a primary control program and various kinds of application programs that are executed by the CPU 2, as well as data and the like relating to each of these programs. Further, in accordance with a readout request from the CPU 2, the storage apparatus 4 outputs these various kinds of programs or data to the CPU 2. In this connection, the various programs and data within the storage apparatus 4 are each stored in a format that can be readout and executed by the CPU 2.

The input apparatus 5 comprises a keyboard comprising character keys, numeric keys and various function keys, and the like. When a depression operation is performed on the keyboard, the input apparatus 5 outputs to the CPU 2 a depression signal corresponding to the key that was the object of the depression operation.

Further, each time a predetermined time lapses, the display controller 6 executes display control processing that is described later herein, to store raster data that is output from the CPU 2 in the VRAM 7. The display controller 6 then reads out raster data that is stored in the VRAM 7, corrects luminance data included in the raster data that was read out on the basis of a current illumination (described later) that is output from the CPU 2, and outputs the corrected raster data to the display apparatus 8. In this case, the luminance data shows the luminance value of each pixel of a display screen of the display apparatus 8 by a numerical value between “0” and “255”, wherein “0” indicates that the luminance of the corresponding pixel is the minimum luminance and “255” indicates that the luminance of the corresponding pixel is the maximum luminance.

The VRAM 7 stores raster data in accordance with a write request from the display controller 6. Also, in accordance with a readout request from the display controller 6, the VRAM 7 outputs raster data to the display controller 6.

The display apparatus 8 comprises a reflective display element such as an electrophoretic display or a cholesteric liquid crystal panel, that is, a display that performs a display function by utilizing the reflected light of light incident on the display screen. When raster data is output from the display controller 6, the display apparatus 8 displays an image on the reflective display element that corresponds with the output raster data.

The illumination sensor 9 detects the ambient illumination of the display screen of the display apparatus 8 and outputs information regarding the detected illumination to the interrupt controller 10.

Each time a predetermined time lapses, the interrupt controller 10 executes interrupt processing that is described later herein, and determines whether or not the illumination area of the ambient illumination of the display screen has changed. When the illumination area has changed, the interrupt controller 10 outputs data (described later) for the current illumination area and an interrupt signal to the CPU 2.

<Contents of Interrupt Processing>

FIG. 2 is a flowchart that illustrates interrupt processing that is executed by the interrupt controller 10. This interrupt processing is executed each time a predetermined time lapses, and as shown in FIG. 2, in a step S101 thereof, illumination information is readout from the illumination sensor 9.

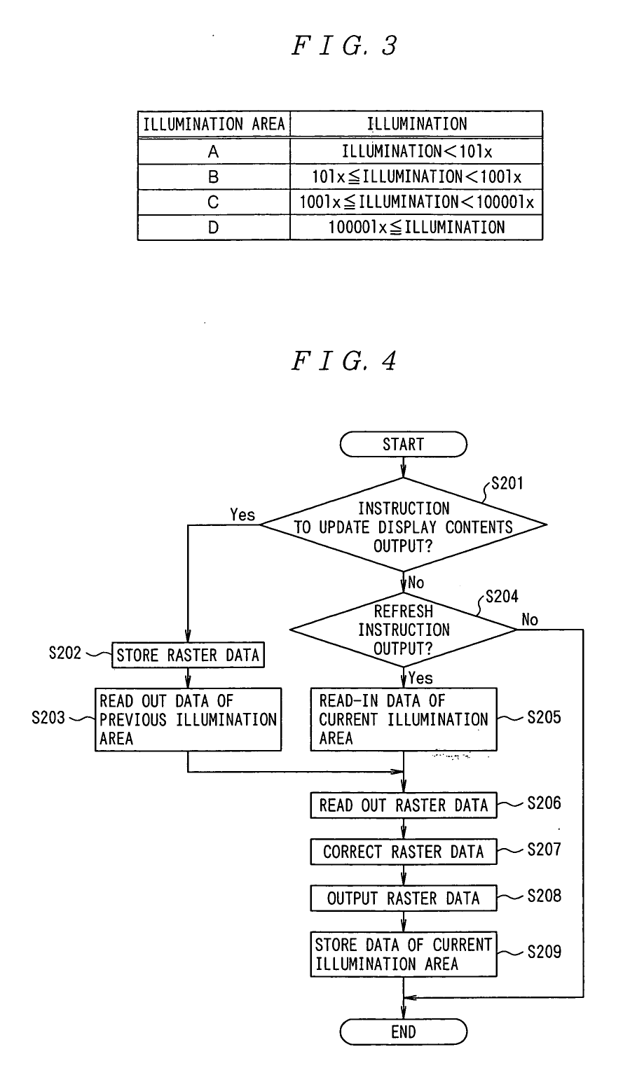

Next, the operation moves to a step S102 to determine the present illumination area (hereunder, also referred to as “current illumination area”) based on the illumination information that was readout in the step S101. More specifically, as shown in FIG. 3, when the illumination is less than 10 [lx], it is determined that the current illumination area is an illumination area A (a considerably dark environment such as that under a street light at night), and when the illumination is greater than or equal to 10 [lx] and less than 100 [lx], it is determined that the current illumination area is an illumination area B (a somewhat dark environment such as that in a corner of a room at night). Further, when the illumination is greater than or equal to 100 [lx] and less than 10000 [lx], it is determined that the current illumination area is an illumination area C (a bright environment such as that outdoors or inside a room in daytime), and when the illumination is greater than or equal to 10000 [lx], it is determined that the current illumination area is an illumination area D (an extremely bright environment such as that outdoors in fine weather).

Next, the operation moves to a step S103. The processing in this step determines whether or not the illumination area that was determined when the processing was last executed is different to the current illumination area that was determined in the step S102. When the areas are different (Yes), the operation moves to a step S104, and when the areas are not different (No) the processing ends. In this connection, when the processing is first executed, the processing executes this step by assuming that the illumination area that was determined when the processing was last executed is illumination area C.

In the step S104, the interrupt controller 10 outputs data for the current illumination area and an interrupt signal to the CPU 2, and the processing is then terminated.

<Contents of Display Control Processing>

FIG. 4 is a flowchart that illustrates display control processing that is executed by the display controller 6. This display control processing is executed each time a predetermined time period lapses, and as shown in FIG. 4, in a step S201 thereof, the display controller 6 determines whether or not image data is being output from the CPU 2, that is, whether or not an instruction to update the display contents is being output, and when an instruction to update the display contents is being output (Yes) the operation proceeds to a step S202, and when an instruction to update the display contents is not being output (No) the operation moves to a step S204.

In the step S202, raster data that is output from the CPU 2 is stored in the VRAM 7.

Next, the operation proceeds to a step S203. In this step, the display controller 6 reads out from the RAM 3 the data of a current illumination area (hereunder, also referred to as “previous illumination area”) that was read-in from the CPU 2 the previous time this processing was executed, and after taking the data of the previous illumination area that was read out as the data for the current illumination area, the operation proceeds to a step S206. In this connection, when this processing is first executed, this step is executed by assuming that illumination area C was stored in the RAM 3 as the data of the previous illumination area.

Meanwhile, in the step S204, the display controller 6 determines whether or not a refresh instruction is being output from the CPU 2, and when a refresh instruction is being output (Yes) the operation proceeds to a step S205, and when a refresh instruction is not being output (No) the processing ends.

In the step S205, after reading the data of the current illumination area that is output from the CPU 2, the operation proceeds to the step S206.

In the step S206, the display controller 6 reads out raster data that is stored in the VRAM 7.

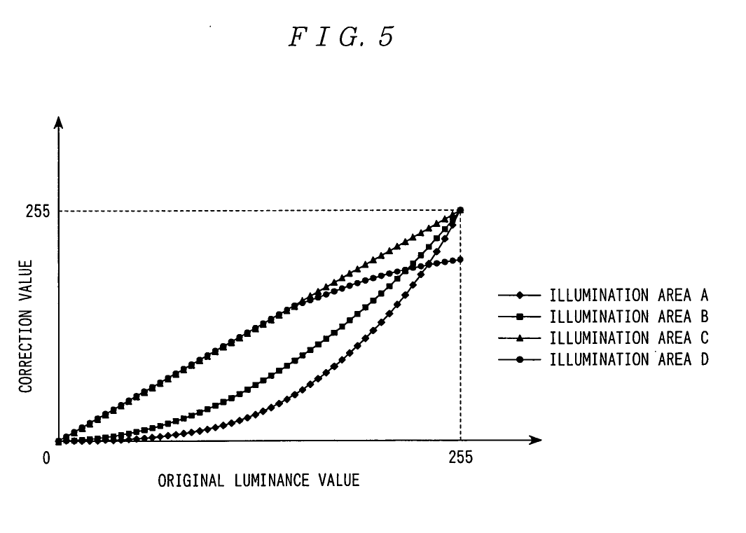

Next, the operation proceeds to a step S207, and as shown in FIG. 5, from a group of LUTs (Look Up Tables) for luminance correction, the display controller 6 selects a LUT for luminance correction that corresponds with the current illumination area that was set in the step S203 or the current illumination area (illumination areas A, B, C, D) that was read-in in the step S205. Then, based on the selected LUT for luminance correction, the display controller 6 corrects luminance data that is included in the raster data that was readout in the step S206.

In this case, for an LUT for luminance correction that corresponds with illumination area A or B, when a luminance value (original luminance value) that is included in the luminance data is “0”, the correction result (correction value) is taken as “0”, when a luminance value is “255”, the correction result is taken as “255”, and when the luminance values are between “0” and “255”, the correction results are represented by a downward convex curve which rises while gradually increasing the gradient of increase together with an increase in the luminance values. In this connection, the LUT for luminance correction that corresponds with the illumination area A carries out a larger correction than the LUT that corresponds with the illumination area B.

For the LUT for luminance correction that corresponds with the illumination area C, when a luminance value that is included in the luminance data is “0”, the correction value is taken as “0”, when a luminance value is “255”, the correction value is taken as “255”, and when the luminance values are between “0” and “255”, the correction values are represented by a straight line in which the correction values increase linearly together with an increase in the luminance values.

Further, for the LUT for luminance correction that corresponds with the illumination area D, when a luminance value that is included in the luminance data is “0”, the correction value is taken as “0”, when a luminance value is “255”, the correction value is taken as “200”, when the luminance values are between “0” and “150”, the luminance values are represented by a straight line in which the correction values increase linearly together with an increase in the luminance values, and when the luminance values are between “150” and “255”, the correction values are represented by an upward convex curve which increases while gradually decreasing the gradient of increase together with an increase in the luminance values.

Thus, according to the portable information terminal 1 of this embodiment, since a LUT for luminance correction that corresponds with an illumination area is selected from a plurality of prepared LUTs for luminance correction and luminance data that is included in raster data is corrected on the basis of the selected LUT for luminance correction, correction can be performed that is suitable for each illumination condition, thereby enabling easy enhancement of the visibility of an image that is the display object.

Further, when an ambient illumination is 10000 [lx] or more, since it is possible to select a LUT for luminance correction that corrects the luminance of a part of an image that is displayed on a reflective display element that has a luminance value of “150” or more to lower the luminance, for example, when in an environment in which the ambient illumination of the reflective display element is remarkably high and the amount of light that is irradiated onto the display screen is therefore remarkably large, the amount of reflected light from a high luminance part of the image that is the display object can be lowered to enable enhancement of the visibility of the image that is the display object.

Next, in a step S208, raster data that was corrected in the step S207 is output to the display apparatus 8.

Thereafter, in a step S209, the current illumination area that was set in the step S203 or the current illumination area that was read-in in the step S205 is stored in the RAM 3 as the previous illumination area, after which the processing ends.

<Operation of the Portable Information Terminal>

Next, the operation of the portable information terminal 1 of this embodiment will be described based on specific circumstances.

First, when an image of characters for which the contours thereof have been subjected to halftoning by anti-aliasing are displayed on the display screen of the portable information terminal 1, and the ambient illumination of the display screen has decreased from 20 [lx] to 5 [lx], it is taken that interrupt processing has been executed at the display controller 6. Then, as shown in FIG. 2, first in the step S101 thereof, illumination information is read out from the illumination sensor 9, that is, information that the illumination is 5 [lx], and in the step S102 it is determined that the current illumination area is illumination area A. Next, the decision in the step S103 is “Yes”, and in the step S104 the data for the current illumination area (illumination area A) and an interrupt signal are output to the CPU 2, after which the CPU 2 outputs the data for the current illumination area and a refresh instruction to the display controller 6.

Further, when data for the current illumination area and a refresh instruction were output from the CPU 2, it is taken that display control processing was executed at the display controller 6. Thus, as shown in FIG. 4, the decision in the step S201 thereof is “No”, and the decision in the step S204 is “Yes”, and in the step S205 the data of the current illumination area that was output from the CPU 2 is read-in. In the step S206, raster data that is stored in the VRAM 7 is read out, and in the step S207, as shown in FIG. 5, a LUT for luminance correction that corresponds to the current illumination area (illumination area A) that was read-in is selected from the group of LUTs for luminance correction, and based on the selected LUT for luminance correction the luminance of a halftone part that is included in the raster data that was read out is corrected to lower the luminance, whereby the contour parts of characters are corrected to be darker. Further, in the step S208, the corrected raster data is output to the display apparatus 8, and in the step S209 the current illumination area is stored in the RAM 3 as the previous illumination area. Then, an image of characters that have a large contrast is displayed on the display apparatus 8 based on the output raster data.

Thus, according to the portable information terminal 1 of this embodiment, since the luminance of an image that is being displayed on the reflective display element is corrected on the basis of the ambient illumination, correction can be carried out that is suitable for each illumination condition, to thereby enable enhancement of the visibility of the image that is the display object.

In addition, when the ambient illumination is less than 10 [lx], because a LUT for luminance correction is selected that corrects the luminance of parts having a luminance value that is less than “255” in the image that is being displayed on the reflective display element to lower the luminance, for example, when in an environment in which the ambient illumination of the display screen of the display apparatus 8 is low and consequently the amount of light that is incident on the display screen is small, the luminance of a halftone part of the image being displayed on the display screen is corrected to a lower luminance. Therefore, the luminance of halftone parts of the contours of characters that are included in the image that is the display object becomes lower (darker), whereby characters that have a large contrast can be displayed to enable enhancement of the visibility of the image that is the display object.

Further, because raster data that is stored in the VRAM 7 is corrected and an image of characters is displayed on the display screen of the display apparatus 8 based on the corrected raster data, for example, the load of the CPU 2 can be reduced in comparison to a method in which raster data that was generated by the CPU 2 is corrected directly without being stored in the VRAM 7 and is then displayed in that state.

In this connection, in the above embodiment the illumination sensor 9 of FIG. 1 and the step S102 of FIG. 2 comprise an illumination detection section that is set forth in the claims, and similarly, the display controller 6 of FIG. 1 and the steps S205 to S208 of FIG. 4 comprise a luminance correction section, the display controller 6 of FIG. 1 and the step S202 of FIG. 4 comprise a generating section, and the display controller 6 of FIG. 1 and the steps S206 to S208 of FIG. 4 comprise a display section.

The above embodiment illustrates one example of the information display of this invention, and is not intended to limit the configuration or the like of this invention.

For example, although an example was illustrated in the above embodiment in which raster data is stored in the VRAM 7 and the stored raster data is corrected, the present invention is not limited thereto. For example, a configuration may be adopted in which raster data that was generated by the CPU 2 is corrected directly without being stored in the VRAM 7, and the corrected raster data is then displayed in that state. By adopting this configuration, the VRAM 7 can be omitted to enable the production cost of the portable information terminal 1 to be lessened.

1. An information display that displays a predetermined image on a reflective display element, wherein the information display comprises an illumination detection section that detects an ambient illumination of the reflective display element, and a luminance correction section that corrects a luminance of an image that is displayed on the reflective display element based on an illumination that was detected by the illumination detection section.

2. The information display according to claim 1, wherein the luminance correction section selects a luminance correction table that corresponds with an illumination detected by the illumination detection section from a plurality of prepared luminance correction tables, and corrects the luminance of an image displayed on the reflective display element based on the selected luminance correction table.

3. The information display according to claim 2, wherein, when an illumination detected by the illumination detection section is greater than or equal to a predetermined illumination, the luminance correction section selects a luminance correction table that corrects a luminance of a part of an image that is displayed on the reflective display element that is greater than or equal to a predetermined luminance to lower the luminance.

4. The information display according to claim 2, wherein, when an illumination detected by the illumination detection section is less than or equal to a predetermined illumination, the luminance correction section selects a luminance correction table that corrects a luminance of a part of an image that is displayed on the reflective display element that is less than or equal to a predetermined luminance to lessen the luminance.

5. (canceled)

6. The information display according to claim 1, comprising a CPU that generates raster data of an image to be displayed on the reflective display element and a display controller that directly displays the raster data that was generated by the CPU on the reflective display element, wherein the luminance correction section corrects luminance data that is included in the raster data that was generated by the raster data generating section.

7. The information display according to claim 2, comprising a CPU that generates raster data of an image to be displayed on the reflective display element and a display controller that directly displays the raster data that was generated by the CPU on the reflective display element, wherein the luminance correction section corrects luminance data that is included in the raster data that was generated by the raster data generating section.

8. The information display according to claim 3, comprising a CPU that generates raster data of an image to be displayed on the reflective display element and a display controller that directly displays the raster data that was generated by the CPU on the reflective display element, wherein the luminance correction section corrects luminance data that is included in the raster data that was generated by the raster data generating section.

9. The information display according to claim 4, comprising a CPU that generates raster data of an image to be displayed on the reflective display element and a display controller that directly displays the raster data that was generated by the CPU on the reflective display element, wherein the luminance correction section corrects luminance data that is included in the raster data that was generated by the raster data generating section.

10. The information display according to claim 1, comprising a CPU that generates raster data of an image to be displayed on the reflective display element, a VRAM that stores raster data that was generated by the CPU, and a display controller that displays raster data that is stored in the VRAM on the reflective display element, wherein the luminance correction section corrects luminance data that is included in the raster data that is stored in the VRAM.

11. The information display according to claim 2, comprising a CPU that generates raster data of an image to be displayed on the reflective display element, a VRAM that stores raster data that was generated by the CPU, and a display controller that displays raster data that is stored in the VRAM on the reflective display element, wherein the luminance correction section corrects luminance data that is included in the raster data that is stored in the VRAM.

12. The information display according to claim 3, comprising a CPU that generates raster data of an image to be displayed on the reflective display element, a VRAM that stores raster data that was generated by the CPU, and a display controller that displays raster data that is stored in the VRAM on the reflective display element, wherein the luminance correction section corrects luminance data that is included in the raster data that is stored in the VRAM.

13. The information display according to claim 4, comprising a CPU that generates raster data of an image to be displayed on the reflective display element, a VRAM that stores raster data that was generated by the CPU, and a display controller that displays raster data that is stored in the VRAM on the reflective display element, wherein the luminance correction section corrects luminance data that is included in the raster data that is stored in the VRAM.
